(19) United States
(12) Patent Application Publication
(10) Pub. No.: US 2001/0051850 A1
(43) Pub. Date: Dec. 13, 2001

(54) Motor vehicle navigation system with image processing

(76) Inventors: Joachim Wietzke, Karlsruhe (DE); Dirk Lappe, Karlsruhe (DE)

Correspondence Address: Samuels, Gauthier & Stevens LLP, Suite 3300, 225 Franklin Street, Boston, MA, 02110, US

(21) Appl. No.: 09/790,210

(22) Filed: Feb. 21, 2001

(30) Foreign Application Priority Data
Feb. 21, 2000 (DE) 100 07 813.3

(51) Int. Cl. G01C 21/26

(52) U.S. Cl. 701/207; 340/988

(57) ABSTRACT

A navigation system for a motor vehicle includes a position acquisition device that identifies the current position of the motor vehicle and provides position data indicative thereof, and an imaging device that captures an image of an area adjacent to the motor vehicle and provides image data indicative thereof. A processing device receives the position data and the image data, and processes the position and image data to provide traffic data that is output to a motor vehicle user. Using information from redundant sources increases the reliability of the position information provided to the motor vehicle user.

### BACKGROUND OF THE INVENTION

The invention relates to the field of motor vehicle navigation systems, and in particular to a motor vehicle navigation system that includes an image capture device and a pattern recognizer to determine the position of the motor vehicle.

A motor vehicle navigation system provides a motor vehicle user with detailed information regarding the current position of the vehicle. The navigation system may use various measurement data to determine the motor vehicle location. The data may be received from devices such as a route acquisition device, an electronic compass, or a GPS receiver. For example, a control arrangement may determine the motor vehicle position using signals provided by the route acquisition device and the electronic compass. In another system a GPS reception unit may provide the data indicative of vehicle position. The navigation system may also include a memory device that includes map data for street routes, crossings, buildings, etc. The position data and the map data can be processed to provide the user of the motor vehicle with a graphical display depicting the exact position of the motor vehicle on a display device. A problem with prior art navigation systems is that they do not acquire visual traffic information such as, for example, traffic and information signs, buildings, forests, etcetera, which frequently provide additional useful information.

### SUMMARY OF THE INVENTION

Briefly, according to an aspect of the present invention, a navigation system for a motor vehicle includes a position acquisition device that identifies the current position of the motor vehicle and provides position data indicative thereof, and an imaging device that captures an image of an area adjacent to the motor vehicle and provides image data indicative of. A processing device receives the position data and the image data, and processes the position and image data to provide traffic data that is indicative of the motor vehicle position and is output to a motor vehicle user

The position data may include may include map data stored in a map information memory device that identifies the vehicle position on a displayable map image. The map data may be combined with the image data, and the resultant data are analyzed and outputted as traffic data.

Combining a known navigation system with an image recognition system, the navigation system can intelligently detect, display, and process traffic and information signs as well as other image information. For example, a speed limit always is valid only until the next crossing. In this case, the system can specifically search for direction or traffic signs after passing a crossing. Houses at the side of the street indicate a town, whereas several trees close together, at both sides of the motor vehicle, indicate a forest (i.e., an area outside a town). This detection ability increases the reliability of the information for the user of the motor vehicle, and the power of the system, especially by multiple data sources (i.e., the position data and the image data).

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 is a block diagram illustration of a motor vehicle navigation system; and

FIG. 2 is a detailed block diagram illustration of the motor vehicle navigation system of FIG. 1.

### DETAILED DESCRIPTION OF THE INVENTION

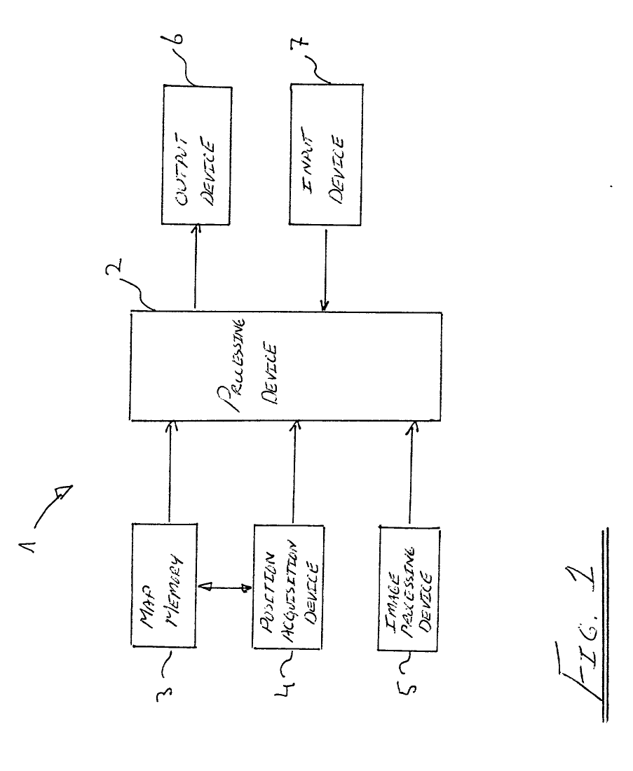

FIG. 1 is a block diagram illustration of a motor vehicle navigation system 1. The system 1 includes a processing device 2 that is connected to a map-information memory device 3, a position acquisition device 4, and an image processing device 5. Map data, such as street directions, street names, road crossings, etcetera are stored in the map-information memory device 3.

The position acquisition device 4 identifies the current position of the motor vehicle and provides a position signal on a line 8 indicative thereof. The position acquisition device 4 may be coupled to the map-information memory device 3. The image processing device 5 captures and recognizes images outside the vehicle, such as for example, traffic signs, direction signs, etcetera and provides an image data signal on a line 10. The processing device 2 processes the position data and the image data on the lines 8, 10, respectively, and controls the navigation system.

The processing device 2 is also connected to an output apparatus 6 that presents (e.g., displays) navigation/traffic information to the motor vehicle user. The processing device 2 may also be connected to an input device 7 (e.g., a keyboard) that allows the motor vehicle user to enter data into the processing device 2. The data may include for example a personal driver profile, a desired route, etc.

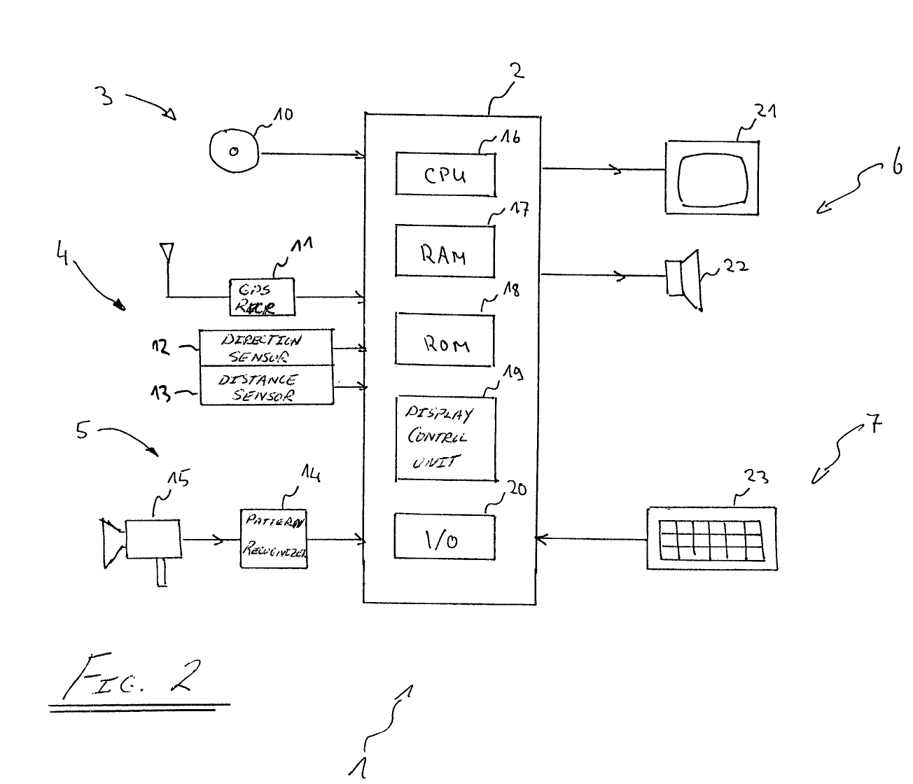

FIG. 2 is a detailed block diagram illustration of the motor vehicle navigation system of FIG. 1. The navigation system 1 of FIG. 2 has the same structure as the navigation system of FIG. 1, and is designed as a on-board navigation system. On-board navigation systems are often characterized in that all the necessary map data are carried along in the vehicle electronically in more or less updated form. Consequently, in FIG. 2 the map-information memory device 3 may include a hard disk 10 to retain the map data. However, it is contemplated that the navigation may be configured as a off-board navigation system, wherein the map data are stored in a memory or in a central station external to the motor vehicle, and map data are broadcast from the central station to the motor vehicle.

In one embodiment the position acquisition device 4 includes a GPS receiver 11, a direction sensor 12, and a distance sensor 13. The image-processing device 5 includes an optical imaging device 15 (e.g., a camera) and a pattern/image-recognition device 14. In a preferred embodiment the imaging device 15 includes an infrared camera capable of capturing images day and night.

The pattern recognition device 14 compares the visual information captured by the imaging device 15 (e.g., direction or traffic signs) with known patterns to recognize the visual information. Pattern-recognition devices are well known, and consequently do not require more detailed explanation. For example, modem intelligent pattern-recognition devices are often equipped with a trained neural network that reduces the computing power required for pattern recognition.

In one embodiment, if a limited amount of computing power is available, it is possible to limit pattern recognition to place-name signs. Simple vector clustering already leads to recognition of a sign.

The processing device 2 includes a central processing unit (CPU) 16, a write/read memory 17, a read-only memory 18, a display control unit 19, and an input/output (I/O) unit 20. In the present example the central process unit 16 is designed as a CPU, however it is contemplated that the central processing may be implemented by a signal processor or another program-controlled unit. In one embodiment the write/read memory 17 includes RAM and stores the current position data and image data. The read-only memory 18, which in the present example includes a ROM, includes the program codes for the central processing unit 16. The input/output unit 20 provides the interface to the external units and typically contains input and output driver circuits.

In the present embodiment the output device 6 includes a display that displays traffic information provided by the processing device 2. The output device 6 may also include a loudspeaker.

A graphic image of the current motor vehicle position is determined by the position acquisition device 4 using the map data stored in the map-information memory device 3. In addition, visual information such as for example traffic/direction signs, groups of trees, conspicuous buildings, route crossings, etcetera adjacent to the motor vehicle (e.g., in front of) are imaged and identified by the image-processing device 5. The image data and position data are combined and analyzed through the processing device 2.

Although the present invention has been shown and described with respect to several preferred embodiments thereof, various changes, omissions and additions to the form and detail thereof, may be made therein, without departing from the spirit and scope of the invention.

What is claimed is:

1. A navigation system for a motor vehicle, comprising:
a position acquisition device that identifies the current position of the motor vehicle, and provides position data indicative thereof;
an imaging processing device that captures an image of an area adjacent to the motor vehicle and provides image data indicative thereof;
a processing device that receives said position data and said image data, and processes said position and image data to provide traffic data; and
an output device for displaying said traffic data.

2. The navigation system of claim 1, wherein said position acquisition device comprises a GPS receiver.

3. The navigation system of claim 2, wherein said image processing device comprises:
an infrared camera that provides a camera output signal;
an image recognition device that receives said camera output signal and processes said camera output signal to identify images within said camera output signal.

4. The navigation system of claim 3, wherein said image processing device comprises:
a camera that provides a camera output signal;
means responsive to said camera output signal, for processing said camera output signal to identify images within said camera output signal.

5. The navigation system of claim 4, wherein said means for processing comprises a neural network pattern recognizer.

6. The navigation system of claim 3, wherein said means for processing includes at least one pattern recognition device to recognize traffic and direction signs and to process these data into said image data.

7. The navigation system of claim 6, wherein said position acquisition device further comprises:
a direction sensor that provides a direction signal indicative of vehicle heading;
a distance sensor that provides a distance signal;
wherein said direction signal and said distance signal are input to said processing device to compute said traffic data.

8. A navigation system for a motor vehicle, comprising:
a GPS receiver that identifies the current position of the motor vehicle, and provides position data indicative thereof,
a direction sensing device that provides a direction signal indicative of vehicle heading;
an infrared camera that regularly captures an image of road signs and provides bit map data indicative thereof;
a pattern recognizer that receives said bit map data and identifies known objects within said bit map data, and provides an image signal indicative thereof;
a processing device that receives said position data, said direction signal and said image data, and processes said position and image data and said direction signal to provide traffic data; and
an output device for displaying said traffic data.

9. The navigation system of claim 8, wherein said pattern recognizer comprises a neural network pattern recognizer.

10. A navigation system of claim 9, wherein said processing unit comprises a central processing unit.

11. A navigation system of claim 10, comprising an input device that receives user command and provides an input signal indicative thereof to said processing device.

12. A navigation system of claim 11, further comprising a map-information memory device that receives said position data and provides bit-map map data indicative of the position of the motor vehicle on a map, wherein said processing device receives and processes said bit-map map data along with said direction signal and said image data to provide traffic data.

13. The navigation system of claim 12, wherein said pattern recognizer comprises means responsive to said bit map data for identifying place-name signs within said bit-map data.
